(19) United States
(12) Patent Application Publication
(10) Pub. No.: US 2026/0039172 A1
(43) Pub. Date: Feb. 5, 2026

(54) POWER GENERATION DEVICE, METHOD AND PORTABLE POWER THEREOF

(71) Applicants: Jue WANG, Beijing (CN); BEIJING JUECHEN TECHNOLOGY Co., LTD., Beijing (CN); GUANGZHOU INSTITUTE OF BLUE ENERGY, Guangzhou (CN)

(72) Inventors: Jue WANG, Beijing (CN); Xia Cao, Beijing (CN)

(21) Appl. No.: 19/356,130

(22) Filed: Oct. 12, 2025

Related U.S. Application Data
(63) Continuation of application No. PCT/CN2023/117170, filed on Sep. 6, 2023.

(51) Int. Cl. H02K 7/18; H02K 35/04

(52) U.S. Cl. CPC H02K 7/1853; H02K 35/04

(57) ABSTRACT

The present invention relates to the technical field of power generation equipment, and specifically to a power generation device and method thereof. The device includes an power field generation device and a coil. When the power field generation and the coil are rotated relatively, the electromagnetic field lines are cut by the coil, thereby the induced current is generated and the electromotive force is induced within the coil. The method is simple and practical, with a wide range of applications. It can convert various forms of energy fields into electrical energy and is suitable for the development of new energy sources, energy recovery and effective reuse. It will have an immeasurable impact on power generation technology, the effective utilization of energy and classical physics. This research belongs to a new generation technology in the field of new energy.

### FIELD OF THE INVENTION

The present invention relates to the technical field of power generation devices, and more particularly to a power generation device, a power generation method of the power generation device and a portable power with the power generation device.

### BACKGROUND OF THE INVENTION

Common power generation methods include thermal power generation, hydropower generation, nuclear power generation, wind power generation, and tidal power generation. All these power generation methods need to use electromagnetic generators to convert mechanical energy into electrical energy. Although they utilize various energy sources, their essence is electromagnetic power generation. In people's traditional thinking, it has always been believed that an induced current can only be generated when a coil cuts through magnetic field lines. Among them, the electromagnetic generator mainly utilizes the principle of electromagnetic induction. When a conductor is placed in a constantly changing magnetic field, it cuts the magnetic field lines and thus generates an induced current. The phenomenon of electromagnetic induction was discovered by Faraday in 1831. This discovery promoted the utilization of electricity and the generation of generators, and had a significant impact on the development of social productivity.

People's traditional thinking has always held that the coil cutting the magnetic field lines can generate induced current. After more than two hundred years of development, the electromagnetic generator has gradually become a key power generation equipment adopted in power stations, but it has also limited people's exploration of new power generation methods. There are a large number of energy fields in life, including electrical energy, light energy, thermal energy and wind energy, etc. Due to the lack of effective utilization methods, these energy fields have long been ignored and wasted by people. The present invention provides a brand-new power generation method, which does not require magnets. It only needs an energy field generation device (such as electrical energy, light energy, thermal energy, wind energy and nuclear energy fields) that directly or indirectly generates or changes the electric field and a coil. By rotating the coil or the energy field generation device, the coil cuts the electric field or electromagnetic field lines (Electra-electric induction). It can then generate induced current and induced electromotive force within the coil, achieving the function of power generation. This method does not require additional magnets and is a power generation method of Electra-electric induction. It breaks through the traditional electromagnetic power generation, is simple and practical, and is suitable for the development of new energy, energy recovery and effective reuse. It will have an immeasurable impact in the field of power generation technology.

### SUMMARY OF THE INVENTION

In response to the problems that energy generated by energy fields such as electrical energy, light energy, and thermal energy cannot be effectively utilized based on the electromagnetic power generation principle, the present invention provides a power generation device, a power generation method for the power generation device and a portable power with the power generation device.

The object of the present invention is to provide a power generation device. The power generation device includes an energy field generation device and a coil. The energy field generation device is used to directly or indirectly generate an electric field or electromagnetic field. Mentioned in coil placed on field produces electric field or electromagnetic field in the device, and can be produced in the electric field or produced in the electromagnetic field and field device relative motion, makes the coil cutting line of electric field or electromagnetic field line, and then to produce induced current in the coil and the induced electromotive force.

In the power generation device of the present invention, the energy field generation device includes any one or more of electrical energy, light energy, thermal energy, wind energy and nuclear energy.

In the power generation device of the present invention, the energy field generation device includes a device that directly generates an electric field.

In the power generation device of the present invention, the energy field generation device includes a device that indirectly generates an electric field.

In the power generation device of the present invention, the energy field generation device includes a device that directly generates an electromagnetic field.

In the power generation device of the present invention, the energy field generation device includes a device that indirectly generates an electromagnetic field.

In the power generation device of the present invention, the device that directly generates an electric field include one or more of the following: an ionizing radiation electric field generation device, an electrostatic induction generation device, an external electric field generation device, a leakage electric field generation device, a high-voltage electrostatic field generation devices, a power source that generate a radiated electric field or leakage field, a device that generating a changing electric field or electrostatic field through friction, and a temperature difference generator for generating a spatial electric field.

In the power generation device of the present invention, the device that indirectly generates electric field include one or more of the following: a light source generation device, a heat source generation device, a wind energy generation device, and a nuclear energy generation device.

In the power generation device of the present invention, the light source generating device is used to provide a light source. The coil is located within the electric field or electromagnetic field generated by the light source generation device and generates an induced current by cutting the electric field lines or electromagnetic field lines generated by the light source generation device.

In the power generation device of the present invention, the light source generation device includes any one of fluorescent lamps, incandescent lamps or torches.

In the power generation device of the present invention, the heat source generation device is used to provide thermal energy. The coil is located within the electric field generated by the heat source generating device and generates an induced current by cutting the electric field lines produced by the thermal energy.

In the power generation device of the present invention, the heat source generation device includes one or more of the following: a combustion-based heat generation device, an electric current-based heat generation device, a friction-based heat generation device, a chemical reaction-based heat generation device, and a dissolution-based heat generation device.

In the power generation device of the present invention, the wind energy generation device is used to provide wind energy. The coil is located within the electric field generated by the wind energy generation device and generates an induced current by cutting the electric field lines produced by the wind energy generation device. The wind energy generation device includes either a blower or a fan.

In the power generation device of the present invention, the nuclear energy generation device is used to provide nuclear energy. The coil is located within the electric field generated by the nuclear energy generation device and generates an induced current by cutting the electric field lines generated by the nuclear energy generation device. The nuclear energy generation device includes either a nuclear reactor device or a nuclear waste device.

In the power generation device of the present invention, the way in which a coil and an energy field generation device move relatively includes any one of rotation, sliding or rolling.

In the power generation device of the present invention, the shape of the coil is one of the following: circular, square, triangular or pentagonal.

In the power generation device of the present invention, the coils are multiple groups, and the multiple groups of coils are connected in series.

In the power generation device of the present invention, the coils are multiple groups, and the multiple groups of coils are connected in parallel.

The another object of the present invention provides a power generation method of the power generation device. The method uses one of the above-mentioned power generation devices to generate electricity, and the power generation device generates electricity based on the method of Electra-electric induction. The method includes the following steps: providing an energy field generation device capable of generating an electric field or an electromagnetic field. The coil is placed in the electric field or electromagnetic field generated by the energy field generating device, and the coil and the energy field generation device move in relative motion by rotating the coil or driving the energy field generation device. The coil is used to cut the electric field line or electromagnetic line, and then generate the induced current.

The third object of the present invention provides a portable power. The portable power includes one of the above-mentioned power generation devices a power generation device. The portable power provides electrical energy to the outside through the current generated by the power generation device.

Compared with the traditional techniques, the present invention has the following beneficial effects.
(1) By rotating the coil or the energy field generation device, the coil and the energy field generation device are made to move relatively, causing the coil to cut the electromagnetic field lines, thereby generating induced current and induced electromotive force within the coil. This method is simple and practical, with a wide range of applications. It can convert various forms of energy fields into electrical energy and will have an immeasurable impact on power generation technology, the effective utilization of energy, and classical physics. This research belongs to a brand-new power generation technology in the field of new energy. Just like Faraday's discovery of electromagnetic induction in the past, it is a completely new method in the field of new energy, which can convert energy into electricity without the use of magnets.
(2) The present invention provides a power generation device, which comprises an energy field generation device and a coil placed in the electric field generated by the energy field generation device. By providing an electric field through the energy field generation device and enabling the coil to cut the electric field lines, an induced current is generated, thereby achieving the purpose of power generation. Through the above-mentioned power generation device, common energies in daily life such as electrical energy, light energy, thermal energy, wind energy and nuclear energy can be effectively converted into electricity. Moreover, during the power generation process, no external magnets are needed. It is a power generation achieved through Electra-electric induction, breaking through the bottleneck of traditional electromagnetic power generation in the recovery and effective utilization of the above-mentioned energies.
(3) The power generation method provided by the present invention adopts the way of power generation via Electra-electric induction, breaking through the traditional electromagnetic power generation method. It can convert various forms of energy common in life into electricity, achieving the reasonable and effective recycling and utilization of natural energy.

### BRIEF DESCRIPTION OF THE DRAWINGS

FIG. 1 is a structural schematic diagram of the power generation device of the present invention, according to the first embodiment.

FIG. 2 is a structural schematic diagram of the power generation device of the present invention, according to the second embodiment.

FIG. 3 is a structural schematic diagram of the power generation device of the present invention, according to the third embodiment.

FIG. 4 is a structural schematic diagram of the power generation device of the present invention, according to the fourth embodiment.

FIG. 5 is a structural schematic diagram of the power generation device of the present invention, according to the fifth embodiment.

FIG. 6 is a structural schematic diagram of the power generation device of the present invention, according to the sixth embodiment.

FIG. 7 is a structural schematic diagram of the power generation device of the present invention, according to the seventh embodiment.

FIG. 8 is a structural schematic diagram of the power generation device of the present invention, according to the eighth embodiment.

FIG. 9 is a structural schematic diagram of the power generation device of the present invention, according to the ninth embodiment.

FIG. 10 is a structural schematic diagram of the power generation device of the present invention, according to the tenth embodiment.

FIG. 11 is a structural schematic diagram of the power generation device of the present invention, according to the eleventh embodiment.

FIG. 12 is a structural schematic diagram of the power generation device of the present invention, according to the twelfth embodiment.

FIG. 13 is a structural schematic diagram of the power generation device of the present invention, according to the thirteenth embodiment.

FIG. 14 is a structural schematic diagram of the power generation device of the present invention, according to the fourteenth embodiment.

FIG. 15 is output current data diagram of the power generation device of the present invention, according to the first embodiment.

FIG. 16 is output voltage data diagram of the power generation device of the present invention, according to the first embodiment.

FIG. 17 is a schematic diagram of the power generation device of the present invention when a 1W bulb is lit, according to the eighth embodiment.

FIG. 18 is output current data diagram of the power generation device of the present invention, according to the sixth embodiment.

FIG. 19 is output voltage data diagram of the power generation device of the present invention, according to the sixth embodiment.

FIG. 20 is a schematic diagram of the power generation device of the present invention when a 28W fluorescent tube lamp is lit, according to the eighth embodiment.

FIG. 21 is output current data diagram of the power generation device of the present invention, according to the ninth embodiment.

FIG. 22 is output voltage data diagram of the power generation device of the present invention, according to the ninth embodiment.

FIG. 23 is output current data diagram of the power generation device of the present invention, according to the tenth embodiment.

FIG. 24 is output voltage data diagram of the power generation device of the present invention, according to the tenth embodiment.

FIG. 25 is output current data diagram of the power generation device of the present invention, according to the eleventh embodiment.

FIG. 26 is output voltage data diagram of the power generation device of the present invention, according to the eleventh embodiment.

FIG. 27 is output current data diagram of the power generation device of the present invention, according to the twelfth embodiment.

FIG. 28 is output voltage data diagram of the power generation device of the present invention, according to the twelfth embodiment.

FIG. 29 is output current data diagram of the power generation device of the present invention, according to the thirteenth embodiment.

FIG. 30 is output voltage data diagram of the power generation device of the present invention, according to the thirteenth embodiment.

The attached Figs are marked as: 1, ionization ball; 2, the coil; 3, hand; 4, rotating shaft; 5, wire; 6, one Watt light bulb; 7, power socket; 8, fur; 9, rubber rod; 10, fluorescent tube; 11, polymethyl methacrylate plate; 12, constant temperature heating platform; 13, chemical reaction-based heating device; 14, ultraviolet lamp; 15, natural wind; 16, high-voltage power tower; 17, windmill; 18, nuclear waste that generates nuclear radiation electromagnetic fields.

### DETAILED DESCRIPTION

To better illustrate the technical problems addressed, solutions proposed, and advantages achieved by the present invention, the following describes in detail with reference to the accompanying drawings and specific embodiments. It should be understood that these implementations are provided solely to explain and demonstrate the invention, not to limit its scope.

Maxwell's equations establishes that changing electric fields and changing magnetic fields are not isolated phenomena, but are intrinsically interconnected, mutually exciting each other to form a unified electromagnetic field. The electromagnetic unification theory posits that electric fields are essentially magnetic fields, and vice versa. However, conventional understanding held that induced current could only be generated by coils cutting through magnetic field lines, while the phenomenon of coils cutting through electric field lines to produce current remained unrealized. This limitation hindered a more comprehensive understanding of the electric-magnetic field equivalence. A groundbreaking discovery in 2019 revealed that electromagnetic fields are generated whenever any materials collide, rub, or come into contact—the so-called “Collision Electro-Magnetic Theory”: the electromagnetic energy can be generated by the collision. Continuous friction and collisions generate changing electric fields, which in turn produce Maxwell's displacement current. In this invention, we have experimentally demonstrated that coils cutting through electric field lines can indeed generate induced current. When applying light energy, thermal energy, or wind energy, the velocity, intensity, and probability of collision among surrounding objects (including their internal molecules) are enhanced, thereby increasing electromagnetic energy. This result in more electromagnetic field lines being cut by the coil, consequently amplifying the induced current and electromotive force generated in the coil. This represents a truly new discovery—an completely original innovation.

The following is a detailed description of a brand-new power generation method. The present invention provides a brand-new power generation method, including an energy field generation device and a coil. The energy field (electrical energy, light energy, thermal energy, wind energy and nuclear energy) generation device can directly or indirectly generate an electric field or electromagnetic field. By rotating the coil or rotating the energy field generation device, the coil and the energy field generation device can produce relative motion. This prompts the coil to cut through the electromagnetic field lines, thereby enabling the generation of induced current and induced electromotive force within the coil.

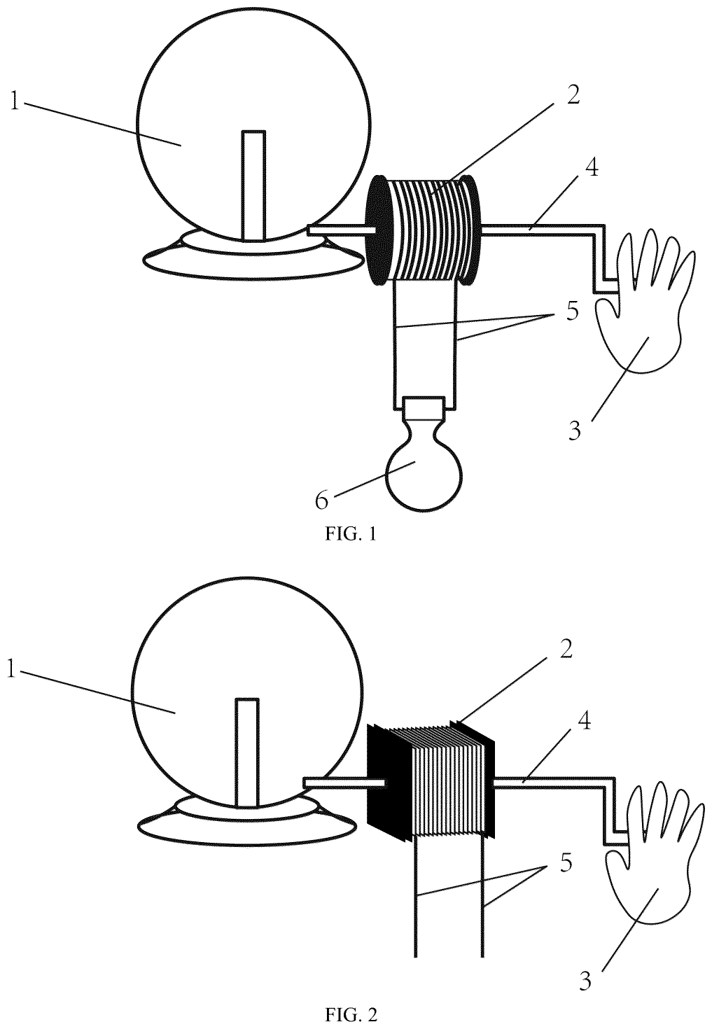

FIG. 1-14 shows the implementation of a brand-new power generation method, including an energy field generation device and a coil.

Optionally, the direct electric field generation device or the electromagnetic field generation device can be an ionizing radiation electric field generation device, an electrostatic induction generation device, an external electric field generation device, a leakage field generation device, a high-voltage electrostatic field generation device, a power source for generating a radiated electric field or a leakage field, or a device for generating a changing electric field or electrostatic field through friction. It can be any device that can generate an electrostatic field or change an electric field, such as a temperature difference generator that produces a spatial electric field.

Optionally, the indirect electric field generation device or the indirect electromagnetic field generation device can be a light source, which can be a natural light source or an artificial light source. The light source itself is an electromagnetic field, and the illumination simultaneously causes more electromagnetic fields to be generated.

Optionally, the indirect electric field generation device or the indirect electromagnetic field generation device can be wind energy, natural wind, a blower, a fan, or any device capable of generating wind energy.

Optionally, the energy field generation device for generation light energy can be a natural light source such as the sun or stars, or an artificial light source such as fluorescent lamps, incandescent lamps, or torches.

Optionally, the energy field generation device for generation thermal energy can be a fire source or any device capable of generating thermal energy, including combustion-based heat generation devices, electric current-based heat generation devices, friction-based heat generation devices, chemical reaction-based heat generation devices, dissolution-based heat generation devices, etc.

Optionally, the nuclear energy generation device can be a nuclear reactor device or a nuclear waste device.

Optionally, the material of the coil can be one or more metals or alloys such as copper, iron, and aluminum.

Optionally, the shape of the coil can be circular, square, triangular, pentagonal or other shapes.

Optionally, the coil can be a group of coils or multiple groups of coils.

Optionally, multiple sets of coils can be connected in series or in parallel.

The following is illustrated in combination with specific implementation examples.

### The First Embodiment

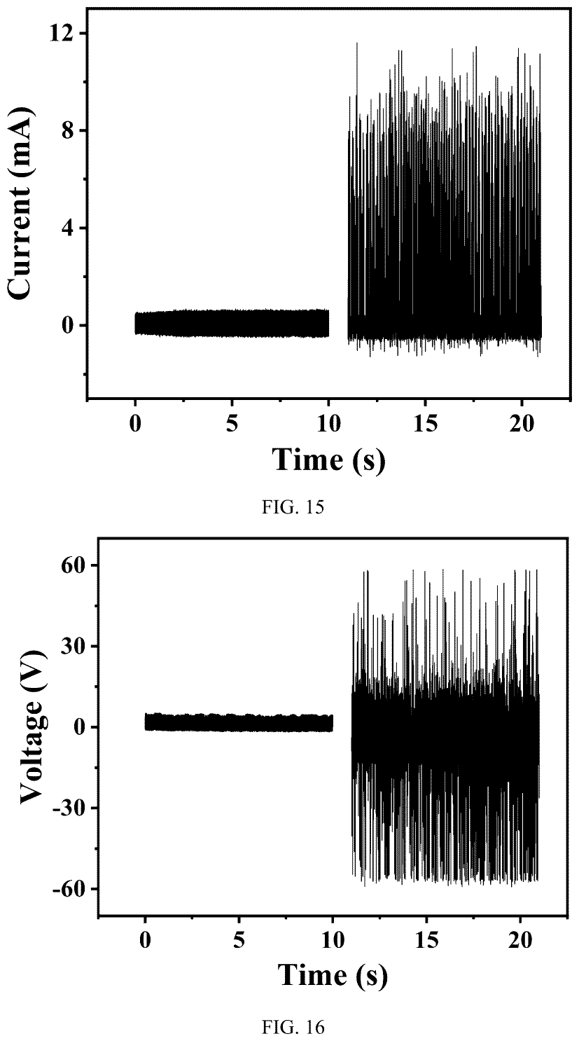

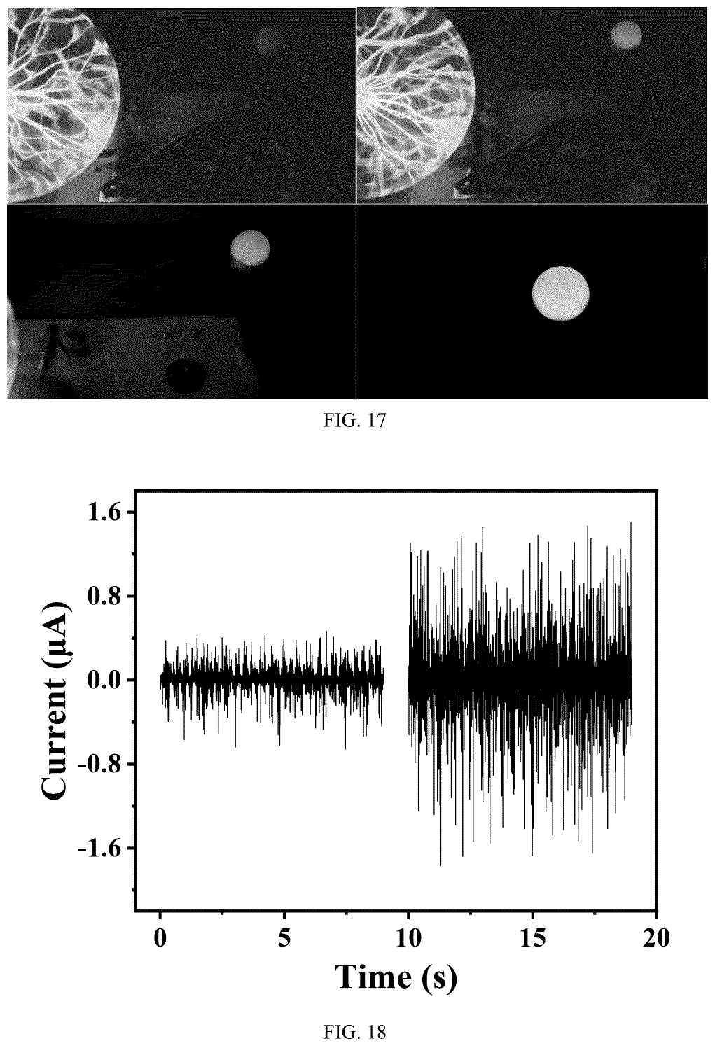

As shown in FIG. 1, a brand-new power generation method in this embodiment comprises: an energy field generation device and a coil. The energy field generation device selects an ionization ball 1 with a power of 8 Watt and a volume of L125 mm*W125 mm*H200 mm. The coil 2 uses a 300-turn circular copper wire coil with a diameter of 0.5 mm. The rotating shaft 4 is driven to rotate by hand crank 3 at a speed of 3 r/s, allowing the coil 2 and the ionization ball 1 to move relatively. This prompts the coil to cut the electromagnetic field lines, thereby enabling the generation of induced current and induced electromotive force within the coil and their discharge through the wire 5. The specific output data of the rotating coil before and after the addition of the energy field generation device are shown in FIG. 15-16, and the output current increased from 0.6 mA to 10.32 mA. When the output voltage rise from 5.0 V to 58.7 V, it can light up a 1 Watt light bulb 6, as shown in FIG. 17.

### The Second Embodiment

As shown in FIG. 2, a brand-new power generation method in this embodiment comprises: an energy field generation device and a coil. The energy field generation device selects an ionization ball 1 with a power of 8 Watt and a volume of L125 mm*W125 mm*H200 mm. The coil 2 uses a 300-turn square aluminum wire coil with a diameter of 0.5 mm. The rotating shaft 4 is driven to rotate by hand crank 3 at a speed of 3 r/s, allowing the coil 2 and the ionization ball 1 to move relatively. This prompts the coil to cut the electromagnetic field lines, thereby enabling the generation of induced current and induced electromotive force within the coil and their discharge through the wire 5.

### The Third Embodiment

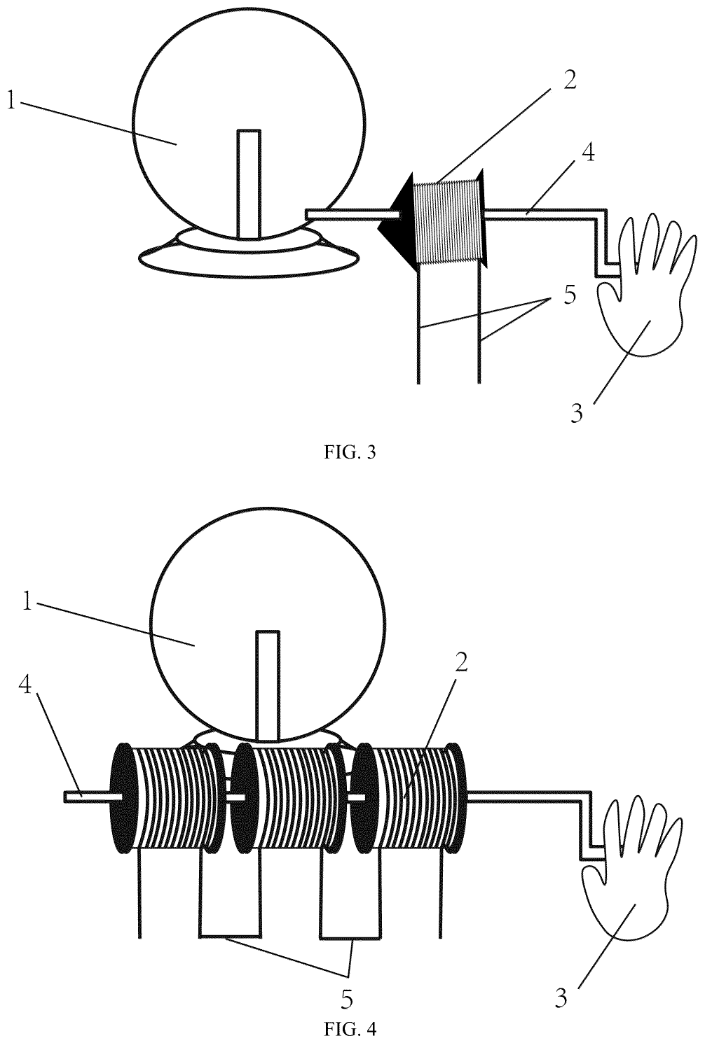

As shown in FIG. 3, a brand-new power generation method in this embodiment comprises: an energy field generation device and a coil. The energy field generation device selects an ionization ball 1 with a power of 8 Watt and a volume of L125 mm*W125 mm*H200 mm. The coil 2 selects a 300-turn triangular alloy coil with a wire diameter of 0.5 mm. The rotating shaft 4 is driven to rotate by hand crank 3 at a speed of 3 r/s, allowing the coil 2 and the ionization ball 1 to move relatively. This prompts the coil to cut the electromagnetic field lines, thereby enabling the generation of induced current and induced electromotive force within the coil 2 and their discharge through the wire 5.

### The Fourth Embodiment

As shown in FIG. 4, a brand-new power generation method in this embodiment comprises: an energy field generation device and a coil. The energy field generation device selects an ionization ball 1 with a power of 8 Watt and a volume of L125 mm*W125 mm*H200 mm. The coil 2 selects three sets of 300-turn circular copper wire coils with a diameter of 0.5 mm, which are connected in series. The rotating shaft 4 is driven to rotate by hand crank 3 at a speed of 3 r/s. Make the coil 2 and the ionization ball 1 move relatively, causing the coil 2 to cut through the electromagnetic field lines, thereby generating induced current and induced electromotive force within the coil 2 and conducting them out through the wire 5.

### The Fifth Embodiment

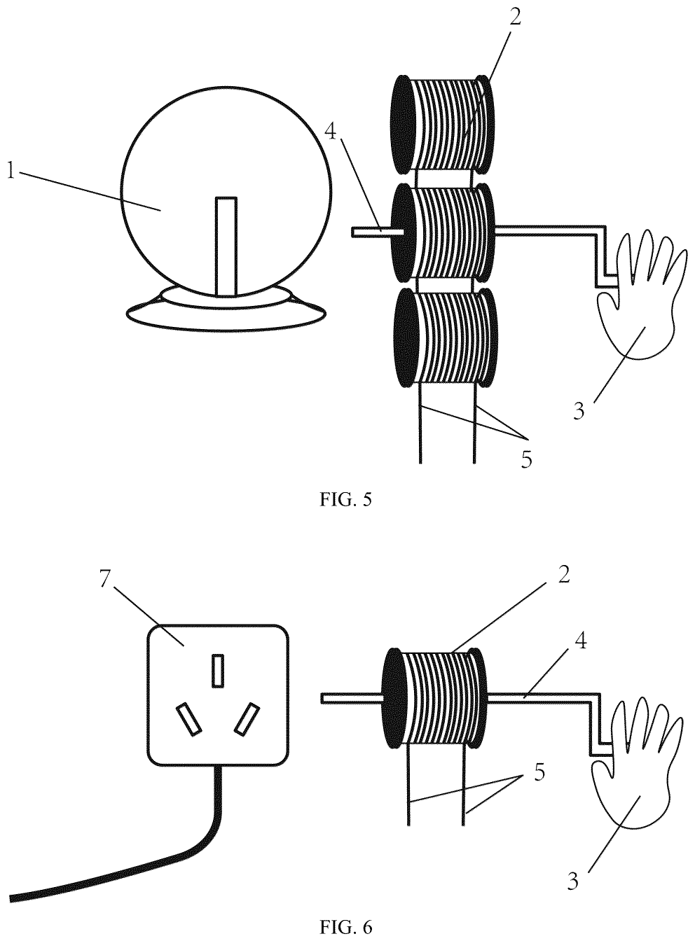

As shown in FIG. 5, a brand-new power generation method in this embodiment comprises: an energy field generation device and a coil. The energy field generation device selects an ionization ball 1 with a power of 8 Watt and a volume of L125 mm*W125 mm*H200 mm. The coil 2 selects three sets of 300-turn circular copper wire coils with a diameter of 0.5 mm, which are connected in parallel. The rotating shaft 4 is driven to rotate by hand crank 3 at a speed of 3 r/s. Make the coil 2 and the ionization ball 1 move relatively, causing the coil to cut through the electromagnetic field lines, thereby generating induced current and induced electromotive force within the coil 2 and conducting them out through the wire 5.

### The Sixth Embodiment

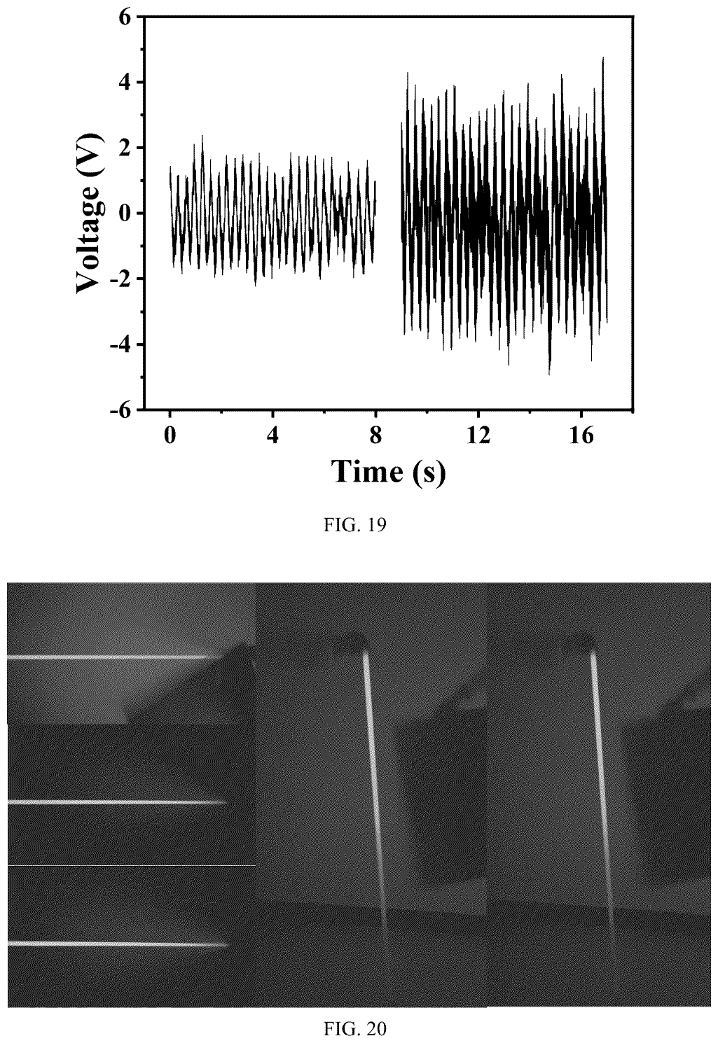

As shown in FIG. 6, a brand-new power generation method in this embodiment comprises: an energy field generation device and a coil. The energy field generation device selects a power socket 7 for generating an electrical energy field with a power of 2200 W. The coil 2 uses a 300-turn copper wire coil with a diameter of 0.5 mm. It is driven by a hand crank 3 to rotate the shaft 4 at a speed of 3 r/s, causing the coil 2 and the power socket 7 to move relatively, which prompts the coil 2 to cut the electromagnetic field lines. Thus, induced current and induced electromotive force can be generated within the coil 2 and conducted out through wire 5. The specific output data of the rotating coil before and after the addition of the energy field generation device are shown in FIG. 18-19, and the output current increased from 0.36 mA to 1.36 mA. The output voltage rose from 1.82 V to 3.81 V.

### The Seventh Embodiment

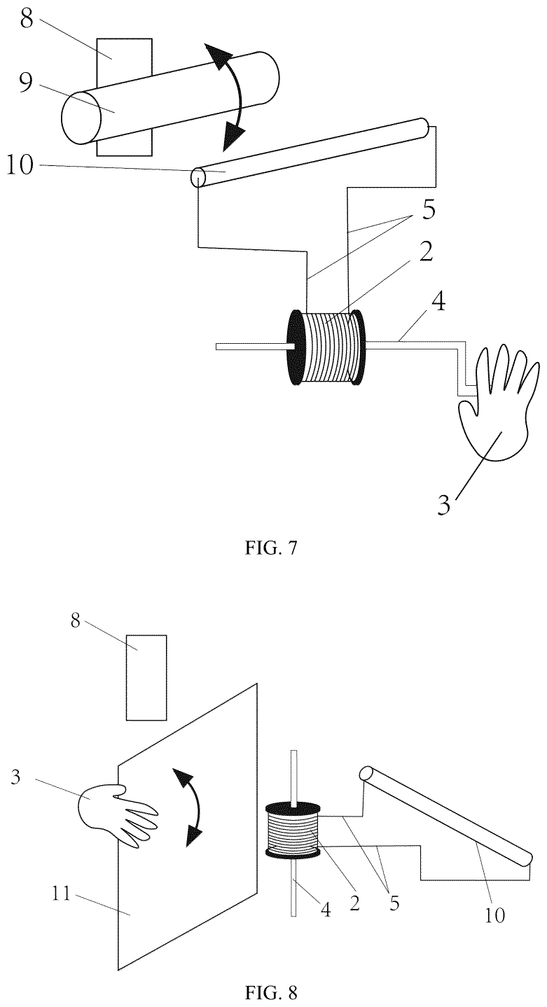

As shown in FIG. 7, a brand-new power generation method in this embodiment comprises: an energy field generation device and a coil. The energy field generation device selects a rubber rod 9 that has been rubbed with fur 8. The fur 8 is made of rabbit hair with a diameter of 20*15 cm, and the rubber rod 9 has a diameter of 40 mm and a length of 500 mm. The coil 2 selects a 300-turn copper wire coil with a diameter of 0.5 mm. By shaking the rubber rod 9, the shaking amplitude is approximately 50 cm, and the swinging frequency is about 3 times per second. At the same time, hand crank 3 drives the rotating shaft 4 to rotate at a speed of 3 r/s, making the coil 2 and the energy field generation device move relatively, causing the coil to cut the electromagnetic field lines. Thus, induced current and induced electromotive force can be generated within the coil and conducted out through wire 5, which can light up a 28Watt fluorescent tube lamp 10.

### The Eighth Embodiment

As shown in FIG. 8, a brand-new power generation method in this embodiment comprises: an energy field generation device and a coil. The energy field generation device selects polymethyl methacrylate (PMMA) plate 11 rubbed with fur 8. The fur 8 is 100*150 mm rabbit fur. The thickness of the PMMA plate 11 is 3 mm, the length is 300 mm, the width is 200 mm, the diameter is 40 mm, and the length is 500 mm. Swing the PMMA plate 11 left and right with hand 3, with a swing amplitude of approximately 50 cm and a swing frequency of about 3 times per second. This causes the coil 2 and the energy field generation device to move relatively, prompting the coil to cut the electromagnetic field lines. As a result, an induced current and induced electromotive force can be generated within the coil and discharged through the wire 5. It can also light up a 28 Watt fluorescent tube 10, as shown in FIG. 20.

### The Ninth Embodiment

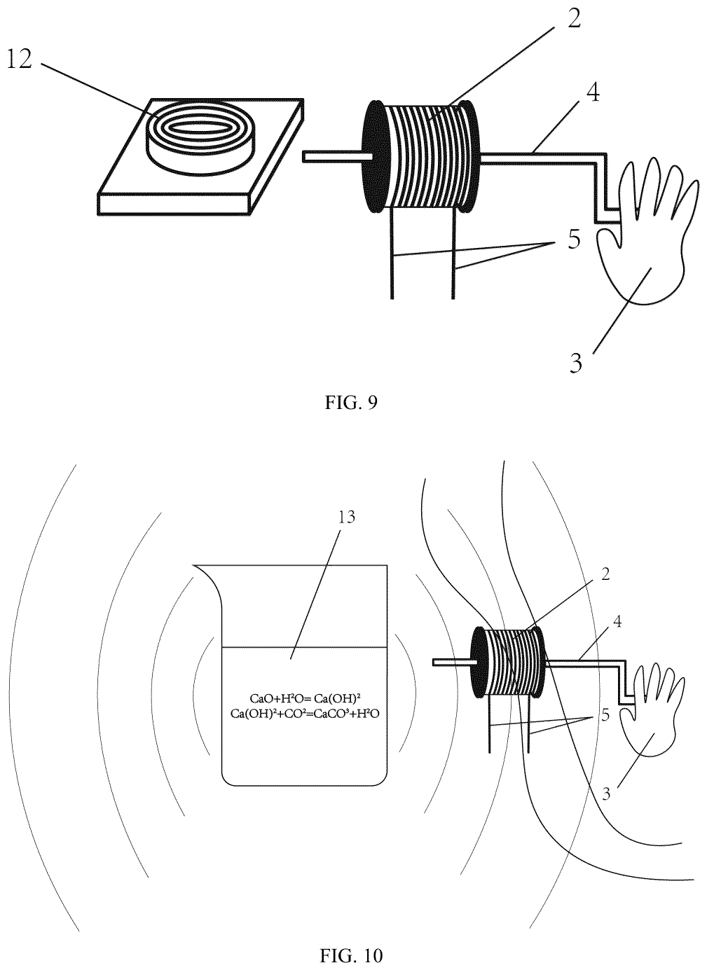

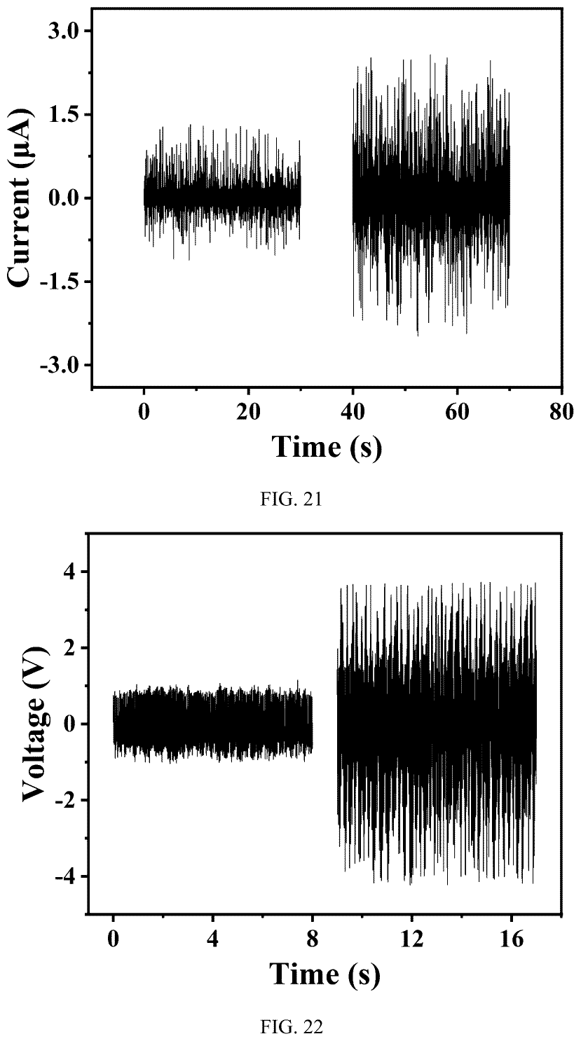

As shown in FIG. 9, a brand-new power generation method in this embodiment comprises: an energy field generation device and a coil. The energy field generation device selects the constant temperature heating platform 12 of the indirect electric field generation device or the electromagnetic field generation device. The power of the heating platform is 1800 W, the external dimensions are 200*300*145 mm, the temperature is selected as 260°, the coil 2 selects a 300-turn copper wire coil with a diameter of 0.5 mm, and the rotating shaft 4 is driven to rotate by hand crank at a speed of 3 r/s. Let the coil 2 and constant temperature heating platform 12 move relatively, causing the coil to cut through the electromagnetic field lines, thereby generating induced current and induced electromotive force within the coil and conducting them out through the wire 5. The specific output data of the rotating coil before and after the addition of the energy field generation device are shown in FIGS. 21-22, and the output current increased from 1.26 mA to 2.46 mA. The output voltage rose from 0.96 V to 3.6 V.

### The Tenth Embodiment

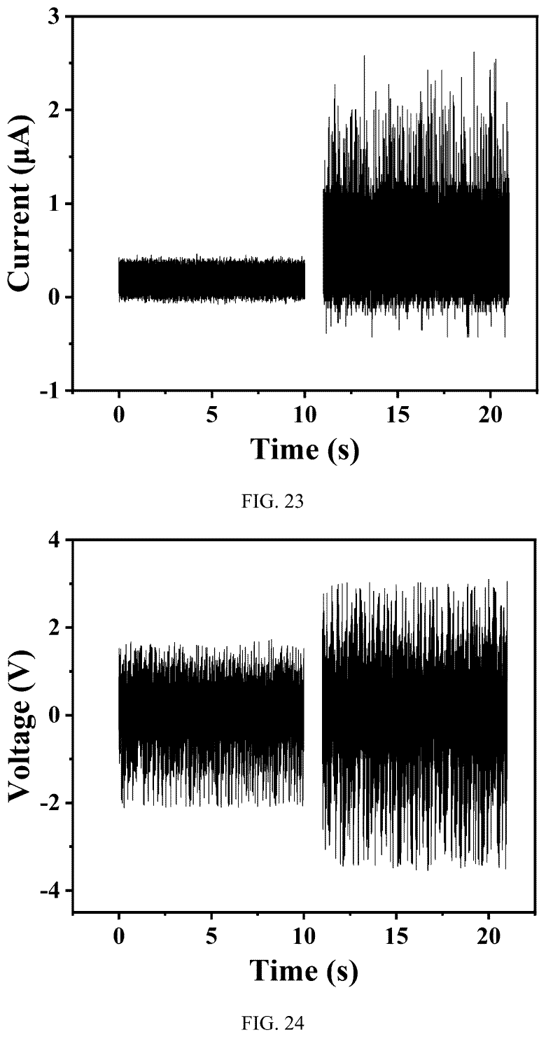

As shown in FIG. 10, a brand-new power generation method in this embodiment comprises: an energy field generation device and a coil. The energy field generation device selects the chemical reaction-based heat generation device 13 that indirectly generates an electric field or electromagnetic field. The chemical reaction options are: CaO+H₂O═Ca(OH)₂, Ca(OH)₂+CO₂=CaCO₃+H₂O. The chemical reaction-based heat generation device 13 consists of 28 g of calcium oxide (Aladdin, 98%), 9 g of ultrapure water, and a 500 ml beaker. The coil 2 is made of 300 turns of copper wire with a diameter of 0.5 mm. After the reaction begins, the rotating shaft 4 is driven to rotate by hand crank at a speed of 3r/s, allowing the coil 2 and the chemical reaction heating device 13 to move relatively. This prompts the coil to cut the electromagnetic field lines, thereby enabling the generation of induced current and induced electromotive force within the coil and their discharge through the wire 5. The specific output data is shown in FIG. 23-24. The output current increased from 0.42 mA to 2.53 mA. The output voltage rose from 1.63 V to 3 V.

### The Eleventh Embodiment

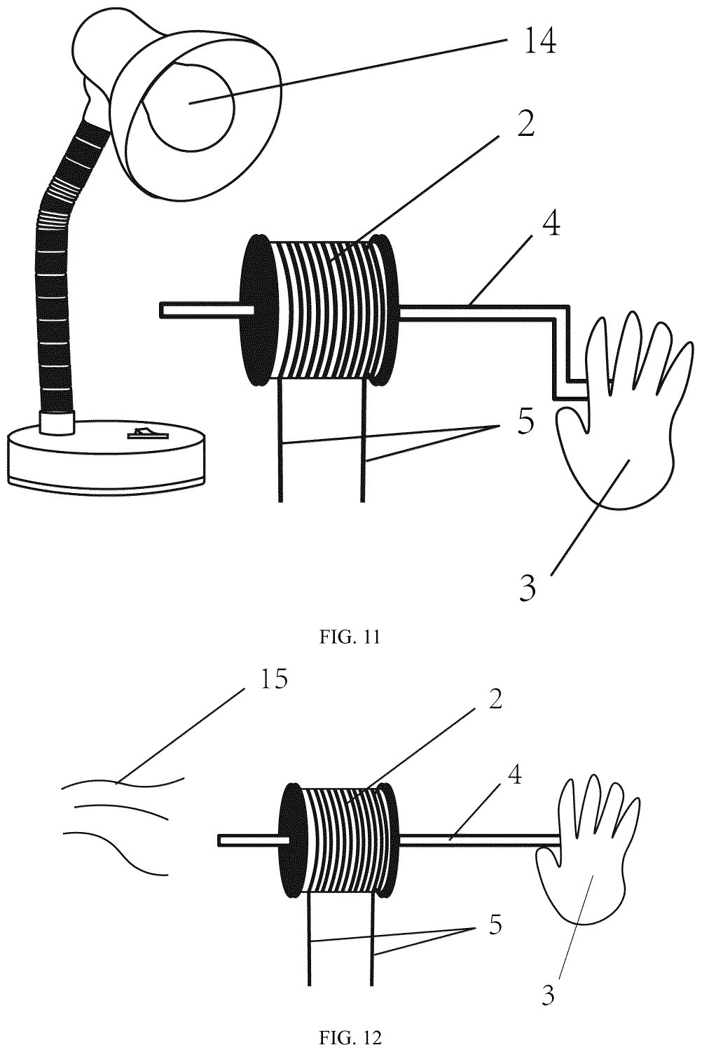

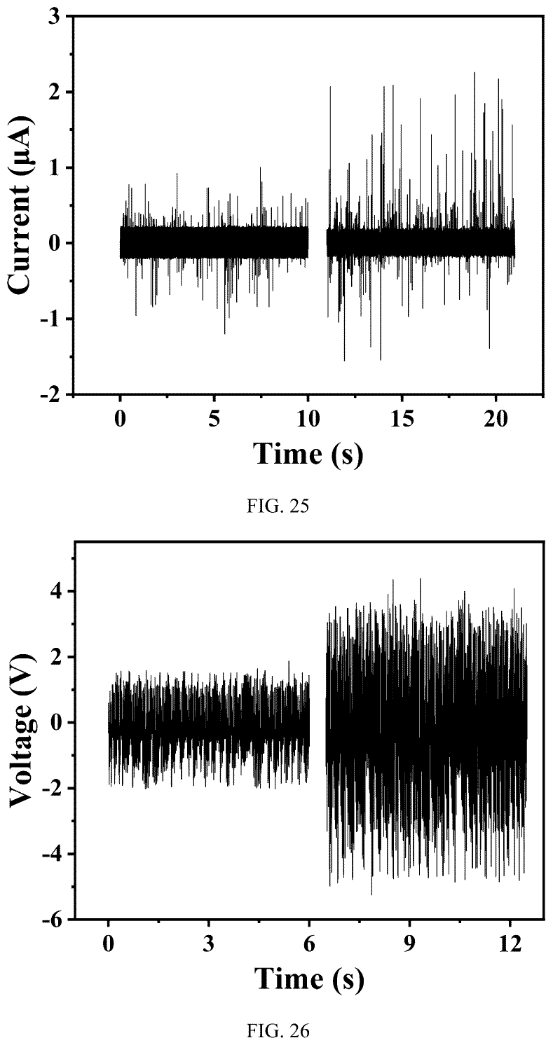

As shown in FIG. 11, a brand-new power generation method in this embodiment comprises: an energy field generation device and a coil. The energy field generation device selects an ultraviolet lamp 14 that indirectly generates an electric field or electromagnetic field. The power of the ultraviolet lamp is 8 Watt and the wavelength is 325 nm. The coil 2 selects a 300-turn copper wire coil with a diameter of 0.5 mm. It is driven by hand crank to rotate the shaft 4 at a speed of 3 r/s, the coil 2 and the ultraviolet lamp 14 to move relatively. This prompts the coil to cut the electromagnetic field lines, thereby generating an induced current and induced electromotive force within the coil and conducting them out through the wire 5. The specific output data of the rotating coil before and after the addition of the energy field generation device are shown in FIGS. 25-26, and the output current increased from 0.64 mA to 2.10 mA. The output voltage rose from 1.5 V to 3.6 V.

### The Twelfth Embodiment

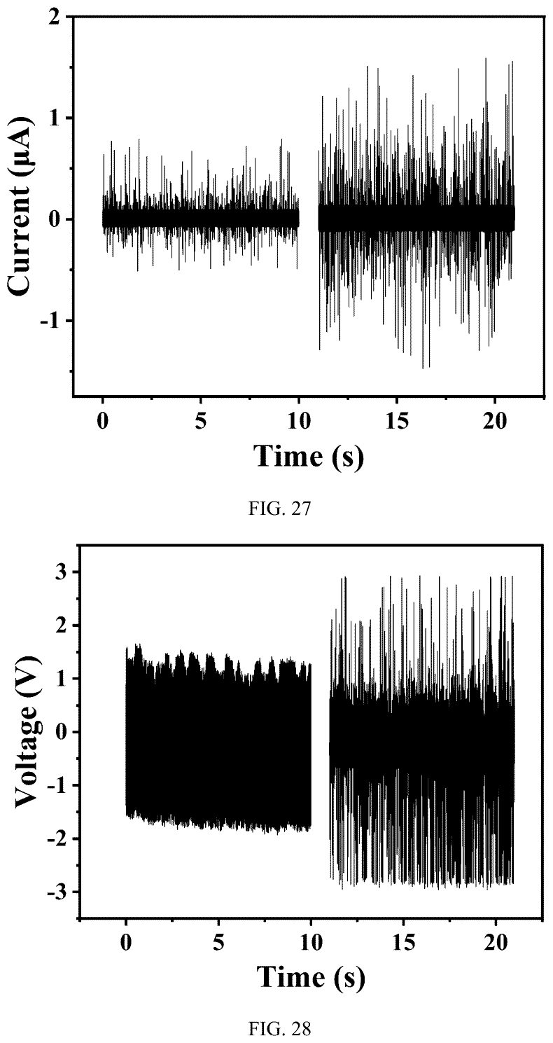

As shown in FIG. 12, a brand-new power generation method in this embodiment comprises: an energy field generation device and a coil. The energy field generation device selects natural wind 15, with a wind speed of approximately 3 m/s. the coil 2 selects a 300-turn copper wire coil with a diameter of 0.5 mm. The rotating shaft 4 is driven to rotate by hand crank at a speed of 3r/s, causing the coil 2 and the natural wind 15 to move relatively. This prompts the coil to cut the electromagnetic field lines, thereby generating induced current and induced electromotive force within the coil and conducting them out through the wire 5. The specific output data is shown in FIG. 27-28, and the output current increased from 0.73 mA to 1.5 mA. The output voltage rose from 1.4 V to 2.9 V.

### The Thirteenth Embodiment

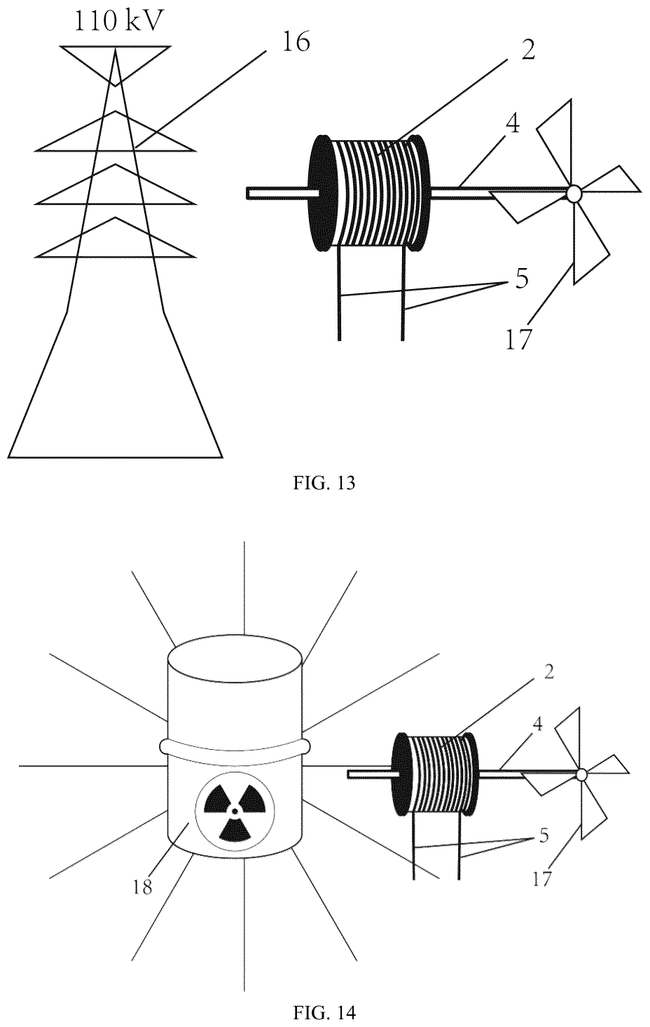

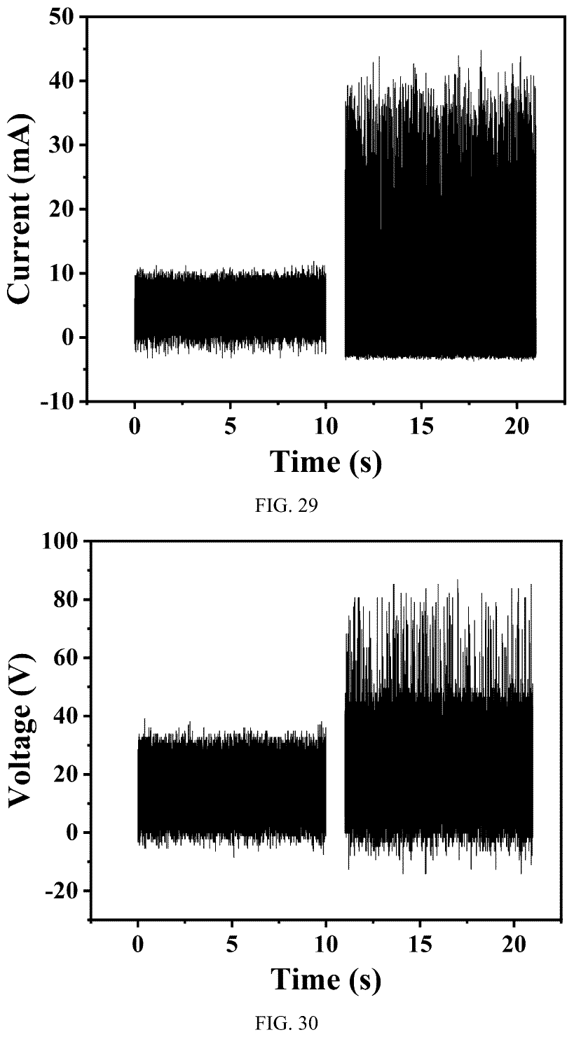

As shown in FIG. 13, a brand-new power generation method in this embodiment comprises: an energy field generation device and a coil. The energy field generation device selects a high-voltage power tower (110 kV) 16. A wind turbine 17 is placed within a safe range of 20 meters to drive the coil 2. The coil 2 is a 300-turn copper wire coil with a diameter of 0.5 mm. Under a gentle breeze, the windmill 17 rotates and drives the rotating shaft 4 to rotate at a speed of 3r/s, causing the coil 2 and the high-voltage power tower 16 to move relatively. This prompts the coil to cut the electromagnetic field lines, thereby generating an induced current and induced electromotive force within the coil and conducting them out through the wire 5. The specific output data is shown in FIG. 29-30, with the output current increased from 10.68 mA to 43.22 mA. The output voltage rose from 36.29 V to 85.54 V.

### The Fourteenth Embodiment

As shown in FIG. 14, a brand-new power generation method in this embodiment comprises: an energy field generation device and a coil. The energy field generation device selects a nuclear waste that generates nuclear radiation electromagnetic fields. The nuclear waste that generates nuclear radiation electromagnetic fields 18 selects the remaining uranium-238 and other radioactive waste that are no longer needed. The coil 2 selects a 300-turn copper wire coil with a diameter of 0.5 mm. Under a gentle breeze, the windmill 17 rotates and drives the rotating shaft 4 to rotate at a speed of 3r/s, causing the coil 2 and the nuclear waste that generates nuclear radiation electromagnetic fields 18 to move relatively. This prompts the coil to cut the electromagnetic field lines, thereby generating induced current and induced electromotive force within the coil and conducting them out through the wire 5.

The above description is the preferred embodiment of the present invention. It should be pointed out that for ordinary technicians in this technical field, several improvements and embellishments can be made without departing from the principles described in the present invention, and these improvements and embellishments should also be regarded as the protection scope of the present invention.

What is claimed is:

1. A power generation device, comprising:
an energy field generation device, which is used to directly or indirectly generate an electric field or electromagnetic field; and
a coil, placed on field produces electric field or electromagnetic field in the device, and can be produced in the electric field or produced in the electromagnetic field and field device relative motion, makes the coil cutting line of electric field or electromagnetic field line, and then to produce induced current in the coil and the induced electromotive force.

2. The power generation device according to claim 1, wherein the energy field in the energy field generation device comprises any one or more of electrical energy, light energy, thermal energy, wind energy and nuclear energy.

3. The power generation device according to claim 1, wherein the energy field generation device comprises a device that directly generates an electric field.

4. The power generation device according to claim 3, wherein the device that directly generates an electric field comprises one or more of the following: an ionizing radiation electric field generation device, an electrostatic induction generation device, an external electric field generation device, a leakage electric field generation device, a high-voltage electrostatic field generation device, a power source that generates a radiated electric field or a leakage electric field, a device that generating a changing electric field or electrostatic field through friction, and a temperature difference generator for generating a spatial electric field.

5. The power generation device according to claim 1, wherein the energy field generation device comprises a device that directly generates an electromagnetic field.

6. The power generation device according to claim 1, wherein the energy field generation device comprises a device that indirectly generates an electromagnetic field.

7. The power generation device according to claim 1, wherein the energy field generation device comprises a device that indirectly generates an electric field.

8. The power generation device according to claim 7, wherein the device that indirectly generates an electric field comprises one or more of the following: a light source generation device, a heat source generation device, a wind energy generation device, and a nuclear energy generation device.

9. The power generation device according to claim 8, wherein the light source generation device is used to provide a light source, The coil is located within the electric field or electromagnetic field generated by the light source generation device and generates an induced current by cutting the electric field lines or electromagnetic field lines generated by the light source generation device.

10. The power generation device according to claim 8, wherein the light source generating device comprises any one of fluorescent lamps, incandescent lamps or torches.

11. The power generation device according to claim 8, wherein the heat source generation device is used to provide thermal energy, the coil is located within the electric field generated by the heat source generation device and an induced current by cutting the electric field lines produced by the thermal energy.

12. The power generation device according to claim 8, wherein the heat source generation device comprises one or more of the following: a combustion-based heat generation device, an electric current-based heat generation device, a friction-based heat generation device, a chemical reaction-based heat generation device, and a dissolution-based heat generation device.

13. The power generation device according to claim 8, wherein the wind energy generation device is used to provide wind energy; the coil is located within the electric field generated by the wind energy generation device and generates an induced current by cutting the electric field lines produced by the wind energy generation device; the wind energy generation device comprises either a blower or a fan.

14. The power generation device according to claim 8, wherein the nuclear energy generation device is used to provide nuclear energy; the coil is located within the electric field generated by the nuclear energy generation device and generates an induced current by cutting the electric field lines generated by the nuclear energy generation device; the nuclear energy generation device comprises any one of the nuclear reactor device and the nuclear waste device.

15. The power generation device according to claim 1, wherein the way in which the coil and the energy field generation device move relatively comprises any one of rotation, sliding or rolling.

16. The power generation device according to claim 1, wherein the shape of the coil is one of the following: circular, square, triangular or pentagonal.

17. The power generation device according to claim 1, wherein the coils are multiple groups, and the multiple groups of coils are connected in series.

18. The power generation device according to claim 1, wherein the coils are multiple groups, and the multiple groups of coils are connected in parallel.

19. A method of power generation, which generates electricity by using the power generation device according to claim 1, and the power generation device generates electricity based on the method of Electra-electric induction; the power generation method comprises the following steps:
providing an energy field generation device capable of generating an electric field or an electromagnetic field;
the coil is placed in the electric field or electromagnetic field generated by the energy field generating device, and the coil and the energy field generation device move in relative motion by rotating the coil or driving the energy field generation device, the coil is used to cut the electric field line or electromagnetic line, and then generate the induced current.

20. A portable power, comprising:
a power generation device according to claim 1; the portable power provides electrical energy to the outside through the current generated by the power generation device.
